(19) United States
(12) Patent Application Publication
(10) Pub. No.: US 2017/0293977 A1
(43) Pub. Date: Oct. 12, 2017

(54) SYSTEMS AND METHODS FOR CONNECTING POTENTIAL SUPPORTERS WITH A LEAD INVESTOR IN A BUSINESS VENTURE

(71) Applicant: Patrick M. HULL, Midlothian, VA (US)

(72) Inventor: Patrick M. HULL, Midlothian, VA (US)

(21) Appl. No.: 15/092,138

(22) Filed: Apr. 6, 2016

(51) Int. Cl. G06Q 40/06; H04N 21/472; H04N 21/478; H04N 21/81; H04N 21/6405

(52) U.S. Cl. CPC G06Q 40/06; H04N 21/8126; H04N 21/6405; H04N 21/478; H04N 21/472

(57) ABSTRACT

In an example implementation of the disclosed invention, a system is provided by which a reality program viewer can participate alongside, or in place of, a lead investor in a business venture presented as part of a broadcast reality program. In some embodiments, information associated with one or more business ventures being presented in an episode of a reality program is provided to viewers of the program, and a viewer may elect to participate in the business venture alongside a lead inventor, for example, by donating funds toward the capital needs of the business venture, by investing in the business venture, by committing to purchase a product or service of the business venture, or the like. In some embodiments, information, such as specifics of the business venture, investment terms, investment and/or customer commitments, or the like, may be updated in real-time, or near real-time, and presented to the viewers, for example, via a dashboard providing various statistics of the business venture being currently presented. Accordingly, embodiments of the disclosed invention provide interactive opportunities for viewers to become supporters of a business venture.

### BACKGROUND

Reality-based television programs have become a popular entertainment option. One type of structured-reality program allows entrepreneurs to participate as contestants and present a business idea or business venture to a panel of potential investors to seek funding for their idea or venture. The panel of investors may question the contestant about the specifics of the business venture and the type of investment being sought by the contestant, and one or more of the investors may negotiate with the contestant in regard to a potential investment. Viewers of such a program may simply enjoy participating as a spectator in viewing the highlights of a pitch and the negotiations between an investor and an entrepreneur. Some viewers may also develop an interest in the entrepreneur's business idea or venture and may have a desire to participate in supporting the venture. However, such viewers currently have no way of participating, or expressing a desire to participate, in the business venture while viewing a program episode. Generally, such a viewer would only be able to participate once the entrepreneur's business venture launches in a commercial environment. Accordingly, systems and methods are needed that would allow viewers to become fans of a business venture, allowing the viewers to express an interest in participating in or supporting a presented business venture.

### SUMMARY

Some or all of the above needs may be addressed by certain implementations of the disclosed technology. In an example implementation of the disclosed invention, a system is provided by which a reality program viewer can participate alongside a lead investor in a business venture being pitched as part of a broadcast reality program. In some embodiments, information associated with one or more business ventures being presented in an episode of a reality program is provided to viewers of the program, and a viewer may elect to participate in the business venture alongside a lead inventor, for example, by donating funds toward the funding of the business venture, by investing in the business venture, by committing to purchase a product or service of the business venture, or the like. In some embodiments, information, such as specifics of the business venture, investment terms, investment and/or consumer commitments, or the like, may be updated in real-time, or near real-time, and presented to the viewers, for example, via a dashboard providing various statistics associated with the business venture currently being pitched in the episode. In some embodiments, the investor panel may also act more as hosts in some situations and not participate in an investment venture, and instead, the viewers would fully provide the required capital for the venture. Accordingly, embodiments of the disclosed invention provide interactive opportunities for viewers to become supporters of a pitched business venture.

Further features and aspects of the present invention are explained in greater detail hereinafter with reference to specific embodiments illustrated in the accompanying drawings, wherein like elements are indicated by like reference designators.

### BRIEF DESCRIPTION OF THE FIGURES

The present invention can be more fully understood by reading the following detailed description together with the accompanying drawings, in which like elements are indicated by like reference designators. The accompanying figures depict certain illustrative embodiments and may aid in understanding the following detailed description. It is to be understood that the present invention is not limited in its application to the details of construction and arrangement of components set forth in the following description of illustrated in the figures. The embodiments depicted are to be understood as exemplary and in no way limiting of the overall scope of the invention. Reference will now be made to the accompanying figures, wherein:

FIG. 1 illustrates an exemplary flowchart of operations for an investment indication system in accordance with embodiments of the present invention; and

FIG. 2 illustrates an exemplary environment 200 in which an investment indication system may operate in accordance with embodiments of the present invention.

### DETAILED DESCRIPTION

Entertainment companies may offer multimedia programs for consumption by a plurality of viewers, such as episodic, reality-based television programs. One such type of episodic reality-based program allows entrepreneurs to participate as contestants and pitch a business idea or venture to a panel of potential investors to seek funding for their idea or venture. In advance of the opportunity to pitch their venture, the contestants may provide background information regarding the idea or venture as well as the level of funding being sought. The producer of the multimedia program may then prepare and produce program episodes allowing one or more contestants to pitch their idea or venture to the panel of potential investors. The program producer may also generate information related to each contestant's pitch to populate an interactive investment indication system that may be accessed by one or more viewers during the broadcast of each program episode. The interactive investment indication system may provide viewers with details regarding each business venture being pitched, including the amount and/or type of funding being sought by each contestant. The interactive investment indication system may also update information regarding the venture as changes in terms, funding, or the like are proposed. The investment indication system provides the ability for viewers to become more engaged while viewing the multimedia program episode and allows viewers to express support for a contestant's business venture, including allowing viewers to commit to assist in providing funding for the venture, either alongside one or more of the investors from the panel or in a solely viewer funded approach.

For example, in some embodiments, a viewer of the multimedia program episode may participate in supporting the contestant's business venture by donating a portion of the funding being solicited by the contestant, by investing in the business venture as a backer (for example, investing a sum of money in the venture in accordance with regulatory requirements, such as Regulation D), by pre-ordering or ordering the product or service being pitched, or the like. Thus, some embodiments of the present invention allow viewers to become engaged and provide support alongside the lead investor or investors (i.e. from the program panel) who commit the remaining capital for the funding of the contestant's business venture. Additionally or alternatively, in some embodiments, the investor panel may not participate in the funding of a particular venture and embodiments would allow for the viewers to commit all the requested funding for the venture.

Embodiments of the present invention provide viewers the ability to interact with an investment indication system where they may receive information about a business venture pitch being presented in a multimedia program episode currently being broadcast or streamed and where they may provide indications of their support for the business venture, for example, investing alongside the investors on the program panel or investing in place of the investor panel. In various embodiments, the interactive capability may be provided by a mobile device application, a web-based application, augmented or virtual reality coordinated with the program broadcast, or the like.

In an example implementation of the disclosed invention, a system is provided by which a reality program viewer can participate alongside, or in place of, a lead investor/host in a business venture presented as part of a broadcast reality program. In some embodiments, information associated with one or more business ventures being presented in an episode of a reality program is provided to viewers of the program, and a viewer may elect to participate in the business venture alongside, or in place of, a lead inventor/host, for example, by donating funds toward the capital needs of the business venture, by investing in the business venture, by committing to purchase a product or service of the business venture, or the like. In some embodiments, information, such as specifics of the business venture, investment terms, investment and/or customer commitments, or the like, may be updated in real-time, or near real-time, and presented to the viewers, for example, via a dashboard providing various statistics of the business venture being currently presented. Accordingly, embodiments of the disclosed invention provide interactive opportunities for viewers to become supporters or fans of a business venture.

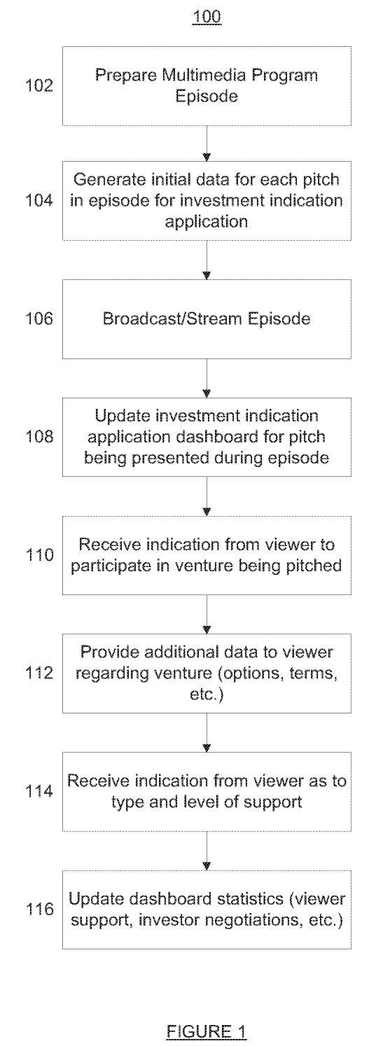

FIG. 1 illustrates an exemplary flowchart of operations 100 for an investment indication system in accordance with embodiments of the present invention. As shown in block 102, multimedia program producer may prepare a multimedia program episode to be broadcast where one or more contestants will pitch their business idea or venture to a panel of potential investors/hosts. The one or more contestants provide background information regarding the idea or venture as well as the level of funding being sought from the investors on the panel or viewers.

At block 104, the producer may generate and provide initial data for each contestant's pitch to the investment indication system. For example, the investment indication system may be provided data regarding details of the pitch, the level and type of investment being sought, the level and types of equity being offered, terms and conditions of the types of investments, types of support that may be provided by viewers, and or the like. The investment application system may use the provided information to generate a display or dashboard, for example using a dashboard agent, to provide information to viewers, such as through the mobile device application, web-based application, augmented or virtual reality, or the like.

At block 106, the multimedia program episode may be broadcast and/or steamed for live viewers. During the multimedia program episode broadcast/streaming, the investment indication system may be updated regarding the pitch currently being presented, details associated with the pitch, information regarding investment or business related questions posed by the investor panel, negotiations between the current contestant and the investor panel, or the like. At block 108, the investment indication application may update a display or dashboard agent in regard to the current pitch, and provide for displaying the updated dashboard to viewers in real-time, or near real-time, for example through the mobile device application, web-based application, augmented or virtual reality, or the like.

At block 110, a viewer may provide an indication, for example through the mobile device application, web-based application, augmented or virtual reality, or the like, to the investment indication system that the viewer is interested in providing support to the contestant currently pitching in the episode. After receiving the indication from a viewer, at block 112, the investment indication system provides additional data to the viewer, for example through the mobile device application, web-based application, augmented or virtual reality, or the like, in regard to options for providing support to the contestant, any terms and conditions of the various investment types, any other investment-related information required (such as required under then-current federal or state regulations), and the like.

At block 114, the viewer may provide an indication of the type of support they wish to commit to the contestant, for example through the mobile device application, web-based application, augmented or virtual reality, or the like. For example, the viewer may indicate they wish to be a Donor and commit to providing a portion of the funding requested, they wish to be a Backer and commit to investing a certain amount of funding (with any limits under then-current federal or state regulation being verified by the investment indication system), they wish to be a Customer and commit to ordering, pre-ordering, or reserving the product or service being pitched by the contestant, or the like.

At block 116, the investment indication system may update the dashboard, using the dashboard agent for example, regarding the statistics associated with the current pitch, in real-time or near real-time. For example, statistics regarding the level of viewer support in different categories may be updated as viewers commit their support (e.g., at block 114) and may be provided for display via the dashboard, for example through the mobile device application, web-based application, augmented or virtual reality, or the like. Additionally, statistics regarding the status of the current pitch, the investor negotiations and level of investment, and the like may be updated and may be provided for display via the dashboard. In the various embodiments, the investment indication system may continuously receive indications of support and update statistics to be provided for display via the dashboard as long as the pitch and subsequent questions and negotiations are ongoing. If the pitch and subsequent negotiations are completed successfully, the investment indication system may finalize the viewer support commitments and provide confirmation to the viewers, and update the dashboard with a final result.

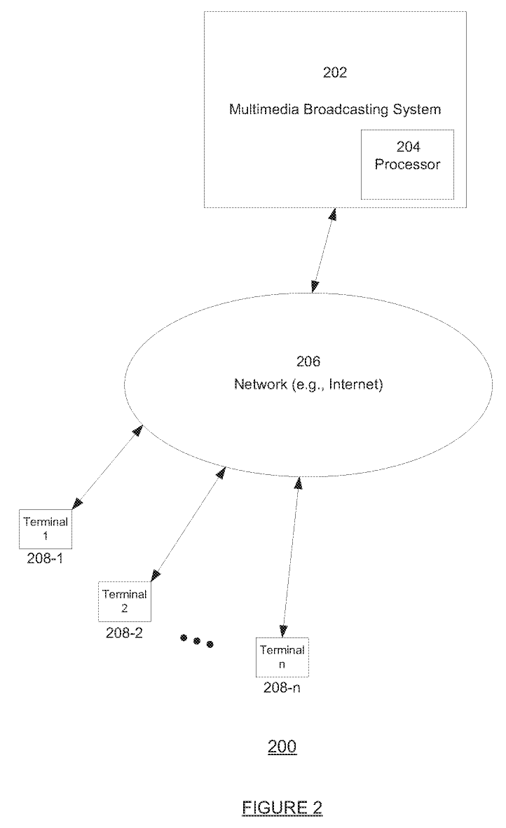

FIG. 2 illustrates an exemplary environment 200 in which an investment indication system may operate in accordance with embodiments of the present invention. As shown in FIG. 2, an exemplary environment 200 may include a multimedia/broadcasting system 202 comprising various components, such as one or more processors, one or more memories, one or more input/output interfaces, one or more communication interfaces, and the like. In some embodiments, the multimedia/broadcasting system 202 comprises one or more processors 204, which provide means for implementing one or more operations of an investment indication system in accordance with the present invention. In various embodiments, the one or more memories may include data and computer-executable instructions, which may be provided to the one or more processors for execution, possibly in conjunction with data received for one or more input/output interfaces and one or more communication interfaces, to implement one or more operations of the investment indication system in accordance with the present invention.

In some embodiments, the multimedia/broadcasting system 202 may allow for the production and recording of a multimedia program, along with generation of additional data associated with the multimedia program, and provide for the transmission of such a multimedia program, for example as a television broadcast, streaming multimedia, or the like, as well as the transmission of the additional associated data, to a plurality of terminals 208-1 to 208-n for consumption by end users. In some embodiments, the transmission of the multimedia program and/or the associated additional data through a network 206, for example, the Internet, a proprietary or private network, other public network, and/or the like.

As shown in FIG. 2, the exemplary environment 200 may further include a plurality of terminal 208-1 to 208-n, such as a smartphone, tablet, mobile device, desktop computer, laptop computer, interactive television, or the like, for example. Such terminals may comprise various components, including one or more processors, one or more memories, one or more input/output interfaces, one or more communication interfaces, and the like. In various embodiments, the one or more memories may include data and computer-executable instructions, which may be provided to the one or more processors for execution, possibly in conjunction with data received for one or more input/output interfaces and one or more communication interfaces, to implement one or more operations of the investment indication system in accordance with the present invention.

In some embodiments, one or more of the plurality of terminals 208-1 to 208-n may receive transmission of the multimedia program and/or the additional associated data, for example through network 206, as part of the investment indication system in accordance with the present invention. The one or more of the terminals 208-1 to 208-n may provide for viewing of the multimedia program by an end user (e.g., viewer), as well as provide for viewing of the additional data associated with the multimedia program as part of the investment indication system. The one or more of the terminals 208-1 to 208-n may further provide for receiving one or more indications from an end user in regard to the multimedia program and the investment indication system and provide for transmission of such indications to the multimedia/broadcasting system 202 as part of the operation of the investment indication system.

The one or more of the terminals 208-1 to 208-n may further provide for receiving additional data from the multimedia/broadcasting system 202 in response to the indications transmitted to the multimedia/broadcasting system 202 as part of the operation of the investment indication system. For example, in some embodiments, a terminal may present a dashboard (e.g., generated by a dashboard agent of the investment indication system) as part of a display interface, the dashboard providing information associated with the multimedia program and the investment indication system, for example, displaying real-time, or near real-time, updates of data associated with multimedia program and the investment indication system. For example, the dashboard may provide statistics regarding investments and support for a business venture currently being pitched as part of the multimedia program, as well as other data associated with the business venture.

Certain embodiments of the present invention are described above with reference to block and flow diagrams of systems and methods and/or computer program products according to exemplary embodiments of the present invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present invention.

Such computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more operations specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more operations specified in the flow diagram block or blocks.

Embodiments of the present invention may provide for a computer program product, comprising a non-transitory computer-usable medium having a computer-readable program code or program instructions embodied therein, said computer-readable program code adapted to be executed to implement one or more operations specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the operations specified in the flow diagram block or blocks.

Accordingly, blocks of the block diagrams and flow diagrams support combinations of means for performing the specified operations, combinations of elements or steps for performing the specified operations and program instruction means for performing the specified operations. It will also be understood that each block of the block diagrams and flow diagrams, and combinations of blocks in the block diagrams and flow diagrams, can be implemented by special-purpose, hardware-based computer systems that perform the specified operations, elements or steps, or combinations of special-purpose hardware and computer instructions.

It should be understood that the specific embodiments of the present invention shown and described herein are exemplary only, and the present invention is not to be limited to the disclosed embodiments. Numerous variations, changes, substitutions, modifications and equivalent arrangements will occur to those skilled in the art without departing from the spirit and scope of the present invention. Accordingly, it is intended that all subject matter described herein and shown in the accompanying figures be regarded as illustrative only, and not in a limiting sense. Although specific terms are employed herein, they are used in a generic and descriptive sense only and not for purposes of limitation.

What is claimed is:

1. An interactive investment indication system comprising:
an investment indication processor; and
one or more user devices;
the investment indication processor comprising:
at least one processor; and
at least one memory comprising computer program instructions, the computer program instructions when executed by the at least one processor, causing the investment indication processor to:
generate investment data associated with a venture pitch;
transmit the investment data in association with a multimedia broadcast;
receive one or more indications of interest in the venture from one or more viewers;
update the investment data; and
transmit the updated investment data; and
the one or more user devices each comprising:
at least one processor; and
at least one memory comprising computer program instructions, the computer program instructions when executed by the at least one processor, causing the user device to:
receive investment data associated with a venture pitch;
provide for display of the investment data;
receive one or more indications of interest in the venture;
transmit the one or more indications to the investment indication processor receive updated investment data; and
provide for display of the updated investment data.

2. The interactive investment indication system according to claim 1 further comprising:
the investment indication processor further comprising computer program instructions when executed by the at least one processor, causing the investment indication processor to:
transmit information comprising at least one of options, terms, or conditions for participation upon receiving the one or more indications of interest in the venture from the one or more viewers; and
the one or more user devices each further comprising computer program instructions when executed by the at least one processor, causing the user device to:
provide for display of the information comprising at least one of options, terms, or conditions for participation.

3. The interactive investment indication system according to claim 1 wherein receiving the one or more indications of interest in the venture from the one or more viewers further comprises receiving indications of a type of participation and a level of support.

4. The interactive investment indication system according to claim 3 wherein the indication of the type of participation comprises at least one of:
a donor providing a portion of requested funding for the venture pitch;
a backer investing a certain amount of requested funding for the venture pitch; and
a customer ordering, pre-ordering, or reserving a product or service of the venture pitch.

5. The interactive investment indication system according to claim 1 further comprising:
the investment indication processor further comprising computer program instructions when executed by the at least one processor, causing the investment indication processor to:
update the investment data during a pitch negotiation; and
transmit the updated investment data; and
the one or more user devices each further comprising computer program instructions when executed by the at least one processor, causing the user device to:
provide for display of the updated investment data.

6. The interactive investment indication system according to claim 5 wherein updating the investment data during a pitch negotiation further comprises updating the investment data based on investment negotiations with a lead investor.

7. The interactive investment indication system according to claim 1 wherein the investment data associated with the venture pitch is generated in association with production of a multimedia program comprising one or more venture pitches.

8. A device comprising:
at least one processor; and
at least one memory comprising computer program instructions, the computer program instructions when executed by the at least one processor, causing the device to:
generate investment data associated with a venture pitch;
generate a display of the investment data in association with a multimedia broadcast;
receive one or more indications of interest in the venture from one or more viewers;
update the investment data; and
generate a display of the updated investment data.

9. The device according to claim 8 further comprising the computer program instructions when executed by the at least one processor, causing the device to:
generate a display of information comprising at least one of options, terms, or conditions for participation upon receiving the one or more indications of interest in the venture from the one or more viewers.

10. The device according to claim 8 wherein receiving the one or more indications of interest in the venture from the one or more viewers further comprises receiving indications of a type of participation and a level of support.

11. The device according to claim 10 wherein the indication of the type of participation comprises at least one of:
a donor providing a portion of requested funding for the venture pitch;
a backer investing a certain amount of requested funding for the venture pitch; and
a customer ordering, pre-ordering, or reserving a product or service of the venture pitch.

12. The device according to claim 8 further comprising the computer program instructions when executed by the at least one processor, causing the device to:
update the investment data during a pitch negotiation; and
generate a display of the updated investment data, via the investment participation dashboard agent.

13. The device according to claim 12 wherein updating the investment data during a pitch negotiation further comprises updating the investment data based on investment negotiations with a lead investor.

14. The device according to claim 8 wherein the investment data associated with the venture pitch is generated in association with production of a multimedia program comprising one or more venture pitches.

15. A method comprising:
generating investment data associated with a venture pitch;
generating a display of the investment data, via an investment participation dashboard agent, in association with a multimedia broadcast;
receiving one or more indications of interest in the venture from one or more viewers;
updating the investment data; and
generating a of the updated investment data, via the investment participation dashboard agent.

16. The method according to claim 15 further comprising:
generating a display of information comprising at least one of options, terms, or conditions for participation, via the investment participation dashboard, upon receiving the one or more indications of interest in the venture from the one or more viewers.

17. The method according to claim 15 wherein receiving the one or more indications of interest in the venture from the one or more viewers further comprises receiving indications of a type of participation and a level of support.

18. The method according to claim 17 wherein the indication of the type of participation comprises at least one of:
a donor providing a portion of requested funding for the venture pitch;
a backer investing a certain amount of requested funding for the venture pitch; and
a customer ordering, pre-ordering, or reserving a product or service of the venture pitch.

19. The method according to claim 15 further comprising:
updating the investment data during a pitch negotiation; and
generating a display of the updated investment data, via the investment participation dashboard agent.

20. The method according to claim 19 wherein updating the investment data during a pitch negotiation further comprises updating the investment data based on investment negotiations with a lead investor.

21. The method according to claim 15 wherein the investment data associated with the venture pitch is generated in association with production of a multimedia program comprising one or more venture pitches.
